(19) United States
(12) Patent Application Publication
(10) Pub. No.: US 2004/0072584 A1
(43) Pub. Date: Apr. 15, 2004

(54) Wireless distribution of multimedia content

(76) Inventor: Ronald J. Kern, Noblesville, IN (US)

Correspondence Address: Ronald K. Aust, TAYLOR & AUST, P.C., 12029 E. Washington St., Indianapolis, IN, 46229, US

(21) Appl. No.: 10/086,333

(22) Filed: Mar. 1, 2002

(51) Int. Cl. H04Q 7/20

(52) U.S. Cl. 455/466; 455/507; 455/41.1; 455/41.2

(57) ABSTRACT

A method for distributing multimedia content provides a wireless controller communicatively coupled to each of a multimedia source and a destination. The wireless controller is adapted to perform the steps of communicating with the multimedia source to generate a first display of a plurality of multimedia works available from the multimedia source, facilitating a selection of at least one multimedia work from the first display of the plurality of multimedia works, and upon the selection being made by a user, commanding the multimedia source to send the at least one multimedia work as the streaming multimedia data to the destination.

### BACKGROUND OF THE INVENTION

1. Field of the Invention

The present invention relates to the distribution of multimedia content, and, more particularly, to the wireless distribution of multimedia content.

2. Description of the Related Art

Typically, digital multimedia works, such as music and video, are stored on a server, or provided by a service provider via the Internet. Such digital multimedia works are commonly retrieved from the server or service provider by downloading the multimedia works as streaming multimedia data by using a personal computer (PC) for playback on a digital playback device. In most cases, such digital playback devices are expensive relative to the cost of traditional electronic equipment, such as for example, a stereo receiver, CD player, DVD player, or television.

What is needed in the art is a method and system for distributing multimedia content that facilitates the convenient selection of multimedia works from a multimedia source and facilitates the playback of the multimedia works using traditional electronic equipment, and does so at a relatively low cost.

### SUMMARY OF THE INVENTION

The present invention provides a method and system for distributing multimedia content that facilitates the convenient selection of multimedia works from a multimedia source and facilitates the playback of the multimedia works using traditional electronic equipment, and does so at a relatively low cost.

The invention, in one form thereof, relates to a method for distributing multimedia content. The method includes the steps of defining a multimedia source for supplying streaming multimedia data; defining a destination for receiving the streaming multimedia data and providing a wireless controller communicatively coupled to each of the multimedia source and the destination. The wireless controller is adapted to perform the steps of communicating with the multimedia source to generate a first display of a plurality of multimedia works available from the multimedia source, facilitating a selection of at least one multimedia work from the first display of the plurality of multimedia works, and upon the selection being made by a user, commanding the multimedia source to send the at least one multimedia work as the streaming multimedia data to the destination.

In another form thereof, the invention relates to a system for distributing multimedia content. A first wireless interface is adapted to be communicatively coupled to a server device. The server provides access to streaming multimedia data. A second wireless interface is adapted to be communicatively coupled to a multimedia playback unit. A wireless controller is provided for controlling a communication between the first wireless interface, the second wireless interface and the wireless controller. The first wireless interface, the second wireless interface and the wireless controller communicate via a wireless communication standard. The wireless controller is configured to instruct the server to transmit the streaming multimedia data via the first wireless interface. Also, the wireless controller is configured to instruct the second wireless interface to process the streaming multimedia data for playback by the multimedia playback unit.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram of a wireless communication system embodying the present invention;

FIG. 2 is a more detailed block diagram of the multimedia subsystem of FIG. 1;

FIG. 3 is a more detailed block diagram of the server/gateway subsystem of FIG. 1;

FIG. 4 is a more detailed block diagram of the wireless controller of FIG. 1; and

FIGS. 5-8 are flow charts depicting the operation of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

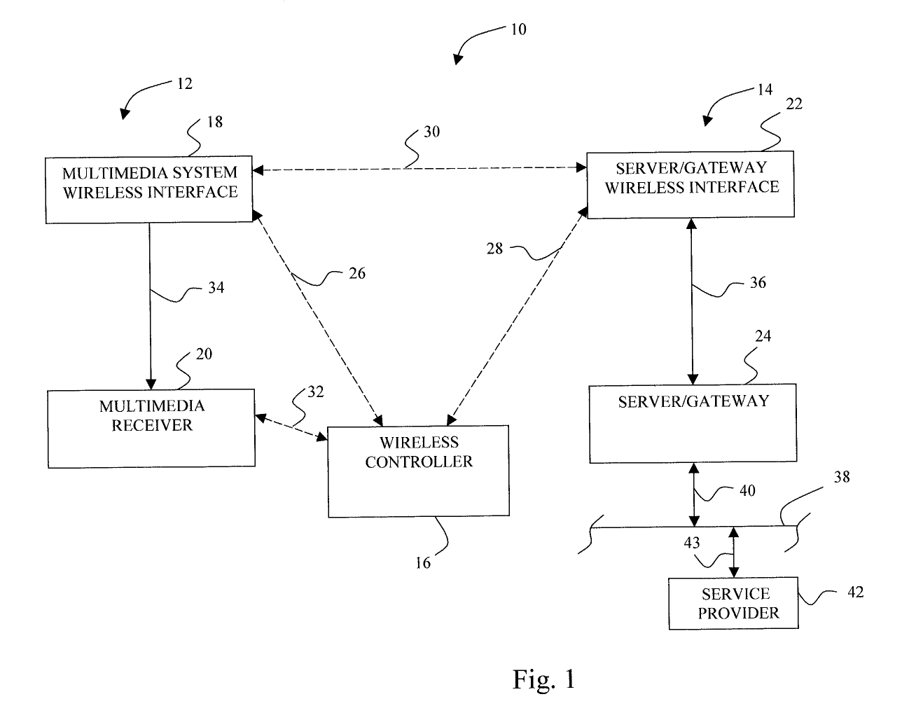

Referring now to the drawings and particularly to FIG. 1, there is shown a block diagram of a wireless communication system 10 embodying the present invention.

Wireless communications system 10 includes a multimedia subsystem 12, a server/gateway subsystem 14 and a wireless controller 16. Multimedia subsystem 12 includes a multimedia system wireless interface 18 and a multimedia receiver 20. Server/gateway subsystem 14 includes a server/gateway wireless interface 22 and a server/gateway 24. As used herein, the term “multimedia” will be used to describe media that can be in any of the forms of audio, video, and combined audio/video.

In FIGS. 1-4, dashed lines represent a wireless communication link, whereas solid lines represent traditional wired communications paths between components. Double-headed arrows represent bidirectional communications. Single headed arrows represent unidirectional communications. Also, two single headed arrows pointing in opposite directions may sometimes be used to signify bi-directional communications.

Wireless controller 16 is in wireless bidirectional communication with multimedia system wireless interface 18 via a bi-directional wireless communication link 26. Wireless controller 16 is in wireless bidirectional communication with server/gateway wireless interface 22 via a bidirectional wireless communication link 28. Multimedia system wireless interface 18 is in wireless bidirectional communication with server/gateway wireless interface 22 via a bidirectional wireless communication link 30. It is preferred that each of bidirectional wireless communication links 26, 28 and 30 is established using a radio frequency (RF) communication standard, such as for example, Bluetooth™, which is a trademark owned by Bluetooth SIG, Inc.

Wireless controller 16 is in wireless bidirectional communication with multimedia receiver 20 via a bidirectional wireless communication link 32. Wireless communication link 32 may be a standard universal infrared communications link to permit wireless controller 16 to perform standard remote control of common functions of multimedia receiver 20, such as for example, ON/OFF, playback volume, and tuner/auxiliary input selection. Preferably, wireless controller 16 is a highly mobile hand-held unit.

Multimedia receiver 20 is communicatively coupled via a communication path 34 to multimedia system wireless interface 18. Multimedia receiver 20 can be, for example, an audio system or a video system, such as a home stereo, a CD player, a DVD player, a television or a combination thereof.

Server/gateway 24 is communicatively coupled via a communication path 36 to server/gateway wireless interface 22. Server/gateway 24 may be, for example, a personal computer (PC) functioning as a multimedia server, and connected to a network 38 via a communication path 40. In some systems, network 38 represents the Internet. Such an Internet connection permits server/gateway 24 to establish Internet communications with an on-line service provider 42. Service provider 42 is communicatively coupled to network 38 via communication path 43. Service provider 42 provides on-line access to multimedia content. As used herein, multimedia content is one or more multimedia works, such as for example, music, videos, or a combination thereof. Thus, server/gateway 24 may function as a server of multimedia content that is located in local memory storage or mass storage available to server/gateway 24, and in addition, server/gateway 24 may function as a gateway for accessing the multimedia content available from service provider 42. Accordingly, server/gateway 24 may for sake of convenience be referred to as server 24. Each of server 24 and service provider 42 are multimedia sources that provide access to multimedia content, and that multimedia content is supplied as streaming multimedia data.

In general, wireless controller 16 controls the communication between server/gateway wireless interface 22, multimedia system wireless interface 18 and wireless controller 16. Wireless controller 16 is configured, for example, to instruct server 24 to transmit the streaming multimedia data via server/gateway wireless interface 22. In addition, wireless controller 16 is configured to instruct multimedia system wireless interface 18 to process the streaming multimedia data for playback by multimedia receiver 20 that functions as a multimedia playback unit.

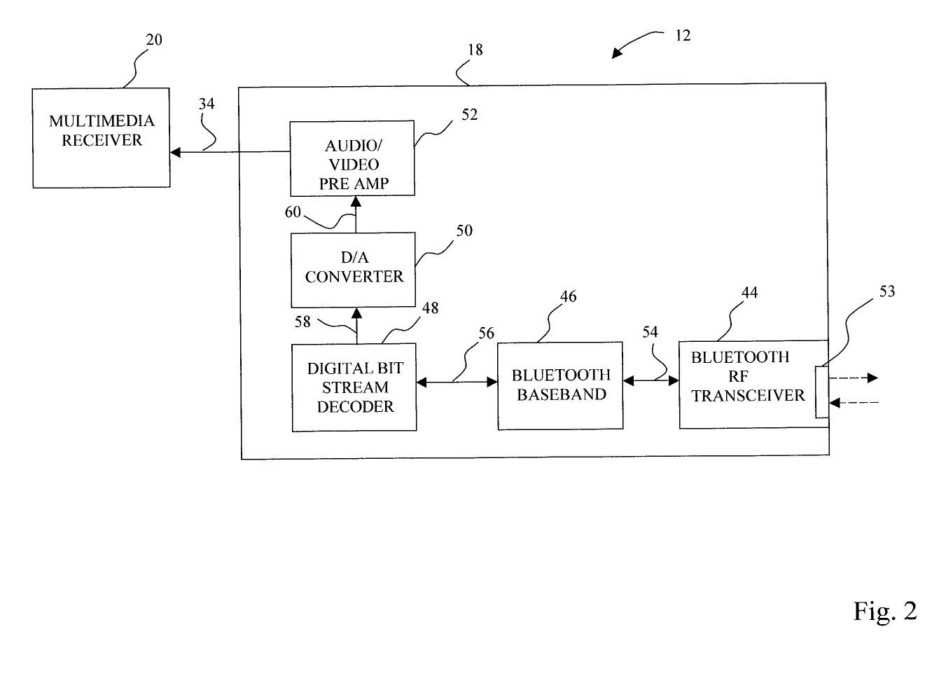

FIG. 2 is a more detailed block diagram of multimedia subsystem 12. Multimedia receiver 20 is communicatively coupled via a communication path 34 to multimedia system wireless interface 18. Each of multimedia receiver 20 and multimedia system wireless interface 18 may include, for example, RCA-type connectors to facilitate this communicative coupling. As such, communications path 34 would include corresponding electrical cables to complete the electrical connection.

Multimedia system wireless interface 18 includes a Bluetooth RF transceiver 44, a Bluetooth baseband 46, a digital bit stream decoder 48, a digital-to-analog (D/A) converter 50 and an audio/video preamplifier 52. Bluetooth transceiver 44 is electrically coupled to Bluetooth baseband 46 via an electrical path 54. Bluetooth baseband 46 is electrically coupled to digital bit stream decoder 48 via an electrical path 56. Digital bit stream decoder 48 is electrically coupled to D/A converter 50 via an electrical path 58. D/A converter 50 is electrically coupled to audio/video preamplifier 52 via an electrical path 60.

Bluetooth RF transceiver 44 is adapted to operate using the Bluetooth RF communications standard. As such, Bluetooth RF transceiver 44 can establish communications with up to seven other Bluetooth RF transceivers. Bluetooth RF transceiver 44 receives via antenna 53, for example, transmitted streaming multimedia data and control signals. Control of Bluetooth RF transceiver 44 is provided by Bluetooth baseband 46. Bluetooth RF transceiver 44 passes all signals received from antenna 53 to Bluetooth baseband 46.

Bluetooth baseband 46 includes digital logic, and may include a programmable processor, that executes control logic and algorithms to control Bluetooth RF transceiver 44 to operate in accordance with the Bluetooth communications standard. In addition, Bluetooth baseband 46 executes control logic and algorithms to process control commands received from wireless controller 16 via Bluetooth RF transceiver 44. For example, if wireless controller 16 sends a command to multimedia system wireless interface 18 to enable processing of a particular streaming multimedia data signal, thereby identifying to multimedia receiver 20 the multimedia source, it is Bluetooth baseband 46 that processes the received command, which in turn selects the particular streaming multimedia data signal for further processing by digital bit steam decoder 48.

Digital bit steam decoder 48 processes the received streaming multimedia data signal to decode the streaming multimedia data signal. Digital bit steam decoder 48 then formats the decoded streaming multimedia data signal for processing by D/A converter 50.

D/A converter 50 converts the formatted streaming multimedia data signal into an analog media signal. D/A converter 50 then sends the analog media signal to audio/video preamplifier 52 for amplification and signal conditioning prior to being supplied to the audio/video input port of multimedia receiver 20 via communication path 34.

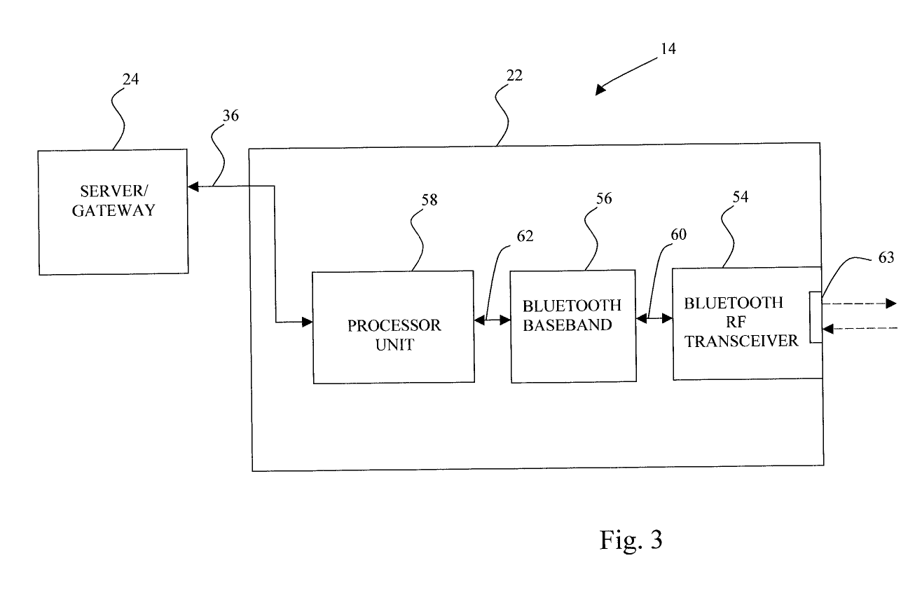

FIG. 3 is a more detailed block diagram of server/gateway subsystem 14. Server/gateway 24 is communicatively coupled via communication path 36 to server/gateway wireless interface 22. Server/gateway 24, such as a personal computer (PC), includes a plurality of peripheral input ports, such as for example, one or more parallel ports, standard serial ports and Universal Serial Bus (USB) ports. In one preferred embodiment, communication path 36 represents a USB connecting cable connecting server/gateway wireless interface 22 to server/gateway 24.

Server/gateway wireless interface 22 includes a Bluetooth RF transceiver 54, a Bluetooth baseband 56, and a processor unit 58. Bluetooth transceiver 54 is electrically coupled to Bluetooth baseband 56 via an electrical path 60. Bluetooth baseband 56 is electrically coupled to processor unit 58 via an electrical path 62.

Bluetooth RF transceiver 54 is substantially identical in structure to Bluetooth RF transceiver 44, and is adapted to operate using the Bluetooth RF communications standard. As such, Bluetooth RF transceiver 54 can establish communications with up to seven other Bluetooth RF transceivers. Bluetooth RF transceiver 54 receives, for example, transmitted streaming multimedia data and control signals. Bluetooth RF transceiver 54 can also transmit streaming multimedia data received from server/gateway 24. Control of Bluetooth RF transceiver 54 is provided by Bluetooth baseband 56. Bluetooth RF transceiver 54 passes all signals received via antenna 63 to Bluetooth baseband 56, and transmits all signals received via server/gateway 24 via Bluetooth RF transceiver 54 and antenna 63.

Bluetooth baseband 56 includes digital logic, and may include a programmable processor, that executes control logic and algorithms to control Bluetooth RF transceiver 54 to operate in accordance with the Bluetooth communications standard. In addition, Bluetooth baseband 56 executes control logic and algorithms to process control commands received from wireless controller 16 via Bluetooth RF transceiver 54. For example, if wireless controller 16 sends a command to Server/gateway wireless interface 22 to enable processing of a particular streaming multimedia data signal, it is Bluetooth baseband 56 that processes the received command, which in turn selects the particular streaming multimedia data signal for further processing by processor unit 58.

When operating in a data stream receive mode, processor unit 58 of server/gateway wireless interface 22 executes instructions to replicate the functions performed by digital bit steam decoder 48 of multimedia system wireless interface 18 to decode the received streaming multimedia data signal, and formats the decoded streaming multimedia data signal for processing.

Command data relating to the selection of a multimedia source available via server/gateway 24, or command data relating to the selection of multimedia works available via server/gateway 24, are processed by processor unit 58 and forwarded to server/gateway 24 via communications path 36.

When operating in a data stream send mode, processor unit 58 of server/gateway wireless interface 22 executes instructions to process the streaming multimedia data received from server/gateway 24 for further processing by Bluetooth baseband 56.

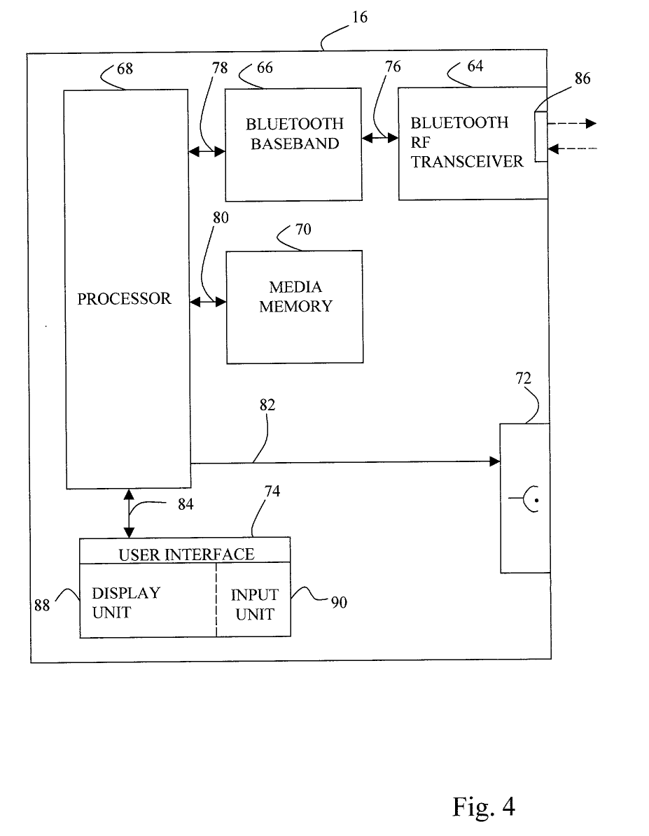

FIG. 4 is a more detailed block diagram of wireless controller 16. Wireless controller 16 includes a Bluetooth RF transceiver 64, a Bluetooth baseband 66, a processor 68, a media memory 70, an output port 72 and a user interface 74. Bluetooth transceiver 64 is electrically coupled to Bluetooth baseband 66 via an electrical path 76. Bluetooth baseband 66 is electrically coupled to processor unit 68 via an electrical path 78. Processor unit 68 is electrically coupled to media memory 70 via an electrical path 80. Processor unit 68 is electrically coupled to output port 72 via an electrical path 82. Processor unit 68 is electrically coupled to user interface 74 via an electrical path 84.

Bluetooth RF transceiver 64 of wireless controller 16 is substantially identical in structure to Bluetooth RF transceivers 44 and 54, and is adapted to operate using the Bluetooth RF communications standard. As such, Bluetooth RF transceiver 64 can establish communications with up to seven other Bluetooth RF transceivers. Bluetooth RF transceiver 64 receives, for example, streaming multimedia data transmitted by server/gateway 24. Bluetooth RF transceiver 64 can also transmit streaming multimedia data retrieved from media memory 70. Control of Bluetooth RF transceiver 64 is provided by Bluetooth baseband 66. Bluetooth RF transceiver 64 passes all signals received via antenna 86 to Bluetooth baseband 56, and transmits all signals via Bluetooth RF transceiver 64 and antenna 86.

Bluetooth baseband 66 includes digital logic to execute control logic and algorithms to control Bluetooth RF transceiver 64 to operate in accordance with the Bluetooth communications standard. In addition, Bluetooth baseband 66 passes control commands generated by wireless controller 16, which in turn are forwarded to Bluetooth RF transceiver 64 for transmission. For example, if wireless controller 16 is sending a command to multimedia system wireless interface 18 to enable processing of a particular streaming multimedia data signal, and sending another command to server/gateway wireless interface 22 for retrieving a particular multimedia work from a particular multimedia source, it is Bluetooth baseband 66 that processes the commands to be transmitted, which in turn sends the enable command and selection command to Bluetooth RF transceiver 64.

When wireless controller 16 is operating as a system controller, processor unit 68 executes instructions to send command data for transmission by Bluetooth RF transceiver 64. For example, command data may relate to the selection of a multimedia source available via server/gateway 24, or may relate to the selection of multimedia works available via server/gateway 24, wherein such command data is transmitted via Bluetooth RF transceiver 64 for reception and processing by server/gateway wireless interface 22. In addition, such command data may relate to the identification of the selected multimedia source device to a destination device, such as multimedia receiver 20, wherein the command data is transmitted via Bluetooth RF transceiver 64 for reception and processing by multimedia system wireless interface 18.

When wireless controller 16 is operating as a destination device for receiving streaming multimedia data, processor 68 executes instructions to replicate the functions performed by digital bit steam decoder 48, D/A converter 50 and audio/video preamplifier 52 of multimedia system wireless interface 18 so as to decode the received streaming multimedia data signal, format the decoded streaming multimedia data signal, convert the formatted streaming multimedia data signal to an analog media signal, amplify the analog media signal, and supply the amplified analog media signal to output port 72.

When wireless controller 16 is operating as a multimedia source device, processor unit 68 executes instructions to send enable commands to the destination device to identify wireless controller 16 as the multimedia source device, and to send streaming multimedia data retrieved from media memory 70, via Bluetooth RF transceiver 64. For example, such command data may relate to the identification to multimedia system wireless interface 18 of wireless controller 16 being selected as the multimedia source.

Output port 72 of wireless controller 16 can accommodate, for example, the connection of a headphone set. Accordingly, the user can easily either sample received streaming multimedia data, or use wireless controller 16 as a playback device to playback multimedia works stored in media memory 70.

User interface 74 includes a display unit 88 and an input unit 90. Display unit 88 includes a monitor screen, such as for example an LCD screen. Input unit 90 can be, for example, a touch screen made integral with display unit 88, or may be a keypad, track ball, pointer, or other input device. Computer code executed by processor 68 generates menu displays on the display screen of display unit 88. Such displays may include, for example, available multimedia sources, multimedia works available from those sources, and multimedia destinations. By user interaction via input unit 90, a user can make desired selections, such as for example, of a desired multimedia source, a particular multimedia work of a plurality of multimedia works, and a desired playback destination.

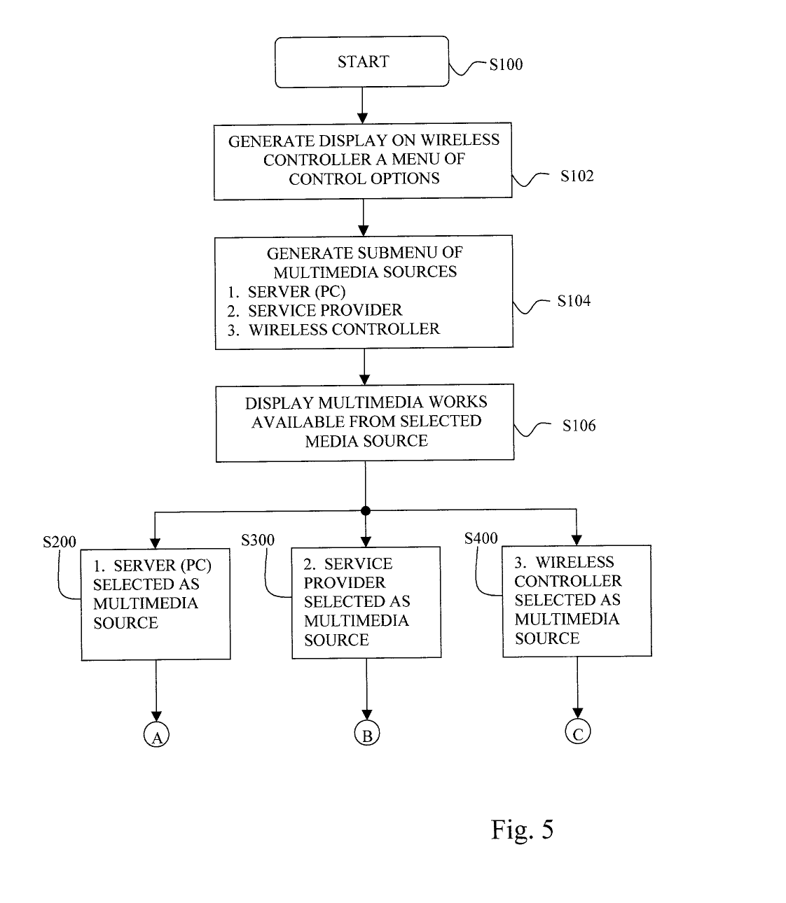

FIGS. 5-8 are flow charts depicting the operation of the present invention.

At step S100, a user starts the process of the invention initially through a power on reset, which can be effected automatically by applying power to wireless controller 16. Alternatively, a user can effect a manual reset of wireless controller 16 by pressing the appropriate key on input unit 90.

At step S102, processor 68 generates a main menu display screen on display unit 88. The main menu will identify a multitude of control options available to the user via wireless controller 16. The main menu may include, for example, a submenu that will list multimedia sources available, a submenu that lists multimedia works available from a particular multimedia source, and a submenu that will list multimedia destinations. The process then proceeds to step S104.

At step S104, a submenu of multimedia sources is generated from which the user can select the desired multimedia source to investigate. The submenu of multimedia sources is generated as follows. Upon selection of the submenu of multimedia sources by entry of an appropriate input by the user via input unit 90, such as a media source options input, wireless controller 16 generates a query that is broadcast via Bluetooth RF transceiver 64 to other Bluetooth RF transceivers within the operating range of Bluetooth RF transceiver 64. Any Bluetooth based devices, such as server 24, within the transmission range of the broadcast will respond by identifying any multimedia source available via the responding wireless interface. For example, through software running on server/gateway 24, server/gateway wireless interface 22 will respond with a list of multimedia sources, such as server (PC) 24 and service provider 42. In addition, if media memory 70, such as a multimedia card or mini-CD, is installed in wireless controller 16, wireless controller 16 will automatically be listed as a multimedia source.

Alternatively, step S104 can be effected by storing a preprogrammed list of multimedia sources in a memory of processor 68 of wireless controller 16.

The generated submenu of available multimedia sources is then displayed on display unit 88 of wireless interface 16. From the generated list, the user selects the desired multimedia source by entry of an appropriate input via input unit 90, such as a multimedia source device selected input.

At step S106, a submenu of multimedia works available from the selected multimedia source is generated and is displayed on display unit 88. The submenu of multimedia works is generated as follows.

If wireless controller 16 is selected as the multimedia source by entry of an appropriate input by the user via input unit 90, then a list of multimedia works stored in media memory 70 is generated and displayed.

If the selected multimedia source is other than wireless controller 16, then upon selection of the desired multimedia source by entry of an appropriate input by the user via input unit 90, wireless controller 16 generates another query that is broadcast via Bluetooth RF transceiver 64 to the Bluetooth RF transceiver corresponding to the selected multimedia source.

If, for example, server 24 is selected as the multimedia source, the query is received at server/gateway wireless interface 22 and processed by server 24. Through software running on server 24, server 24 compiles a list of multimedia works available from server 24. Server 24 then forwards the complied list to server/gateway wireless interface 22, which in turn transmits the list of multimedia works via Bluetooth transceiver 54. Wireless controller 16 then receives the compiled list and generates the submenu of media works available from server 24.

If, for example, service provider 42 is selected as the multimedia source, the query is received at server/gateway wireless interface 22 and processed by server 24. Through software running on server 24, server 24 sends query packets via network 38 to service provider 42, which in turn responds with a list of multimedia works available from service provider 42. Server 24 then forwards the list of multimedia works to server/gateway wireless interface 22, which in turn transmits the list of multimedia works via Bluetooth transceiver 54. Wireless controller 16 then receives the compiled list and generates the submenu of multimedia works available from service provider 42.

From the generated submenu of multimedia works available from a selected multimedia source, the user can select at least one multimedia work from the plurality of multimedia works by entry of an appropriate input via input unit 90, such as a media work selected input.

Following step S106, the process continues in one of process branches S200, S300 or S400. Process branch S200 is pursued if server (PC) 24 was selected as the multimedia source. Process branch S300 is pursued if service provider 42 was selected as the multimedia source. Process branch S400 is pursued if wireless controller 16 was selected as the multimedia source. The process associated with each of process branches S200, S300 and S400 is described below.

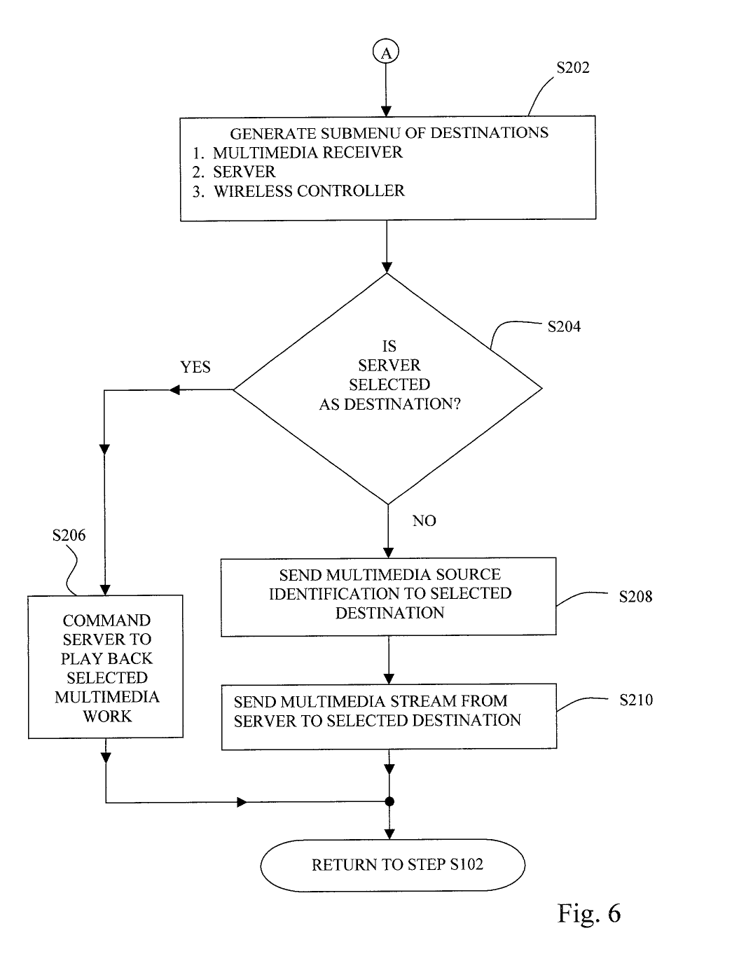

If server (PC) 24 was selected as the multimedia source, then the process continues at step S202 (see FIG. 6). At step S202, a submenu of multimedia destinations is generated from which the user can select the desired multimedia destination. The submenu of multimedia destinations is generated as follows. Upon selection of the submenu of multimedia destinations by entry of an appropriate input by the user via input unit 90, wireless controller 16 generates a query that is broadcast via Bluetooth RF transceiver 64 to other Bluetooth RF transceivers within the operating range of Bluetooth RF transceiver 64. Any Bluetooth based devices, such as multimedia receiver 20 and server 24, within the transmission range of the broadcast will respond by identifying itself as being an available multimedia destination. In addition, wireless controller 16 is automatically listed as a multimedia destination. The list of available multimedia destinations is then displayed on display unit 88.

At step S204, it is determined whether server 24 was selected as the destination.

If the result of the decision at step S204 is YES, then at step S206 wireless controller 16 transmits a command to server 24 via server/gateway wireless interface 22 for server 24 to play back the selected multimedia work. The process then returns to step S102 (FIG. 5).

If the result of the decision at step S204 is NO, then at step S208 wireless controller 16 identifies the multimedia source to the selected destination.

If the destination is wireless controller 16, then wireless controller 16 prepares for receiving the selected multimedia work as streaming multimedia data via Bluetooth RF transceiver 64.

If the destination is multimedia receiver 20, then wireless controller 16 sends an enable command to multimedia system wireless interface 18 to identify to multimedia system wireless interface 18 that server (PC) 24 is the selected multimedia source. The enable command in turn is processed by Bluetooth baseband 46. Bluetooth baseband 46 then responds by preparing multimedia system wireless interface 18 to receive via Bluetooth RF transceiver 44 the selected multimedia work as streaming multimedia data for further processing and signal conditioning by multimedia system wireless interface 18.

At step S210, wireless controller 16 sends a command to the multimedia source device, in this case server (PC) 24, to send the selected multimedia work as streaming multimedia data via server/gateway wireless interface 22. The selected destination then receives, processes and plays back the selected multimedia work. If multimedia receiver 20 was the selected destination, then the selected multimedia work as streaming multimedia data is received and processed at multimedia system wireless interface 18 for playback by multimedia receiver 20. If the destination is wireless controller 16, then wireless controller 16 receives the selected multimedia work as streaming multimedia data via Bluetooth RF transceiver 64, performs processing and signal conditioning, and supplies an analog signal corresponding to the multimedia selection to output port 72.

The process then returns to step S102 (FIG. 5).

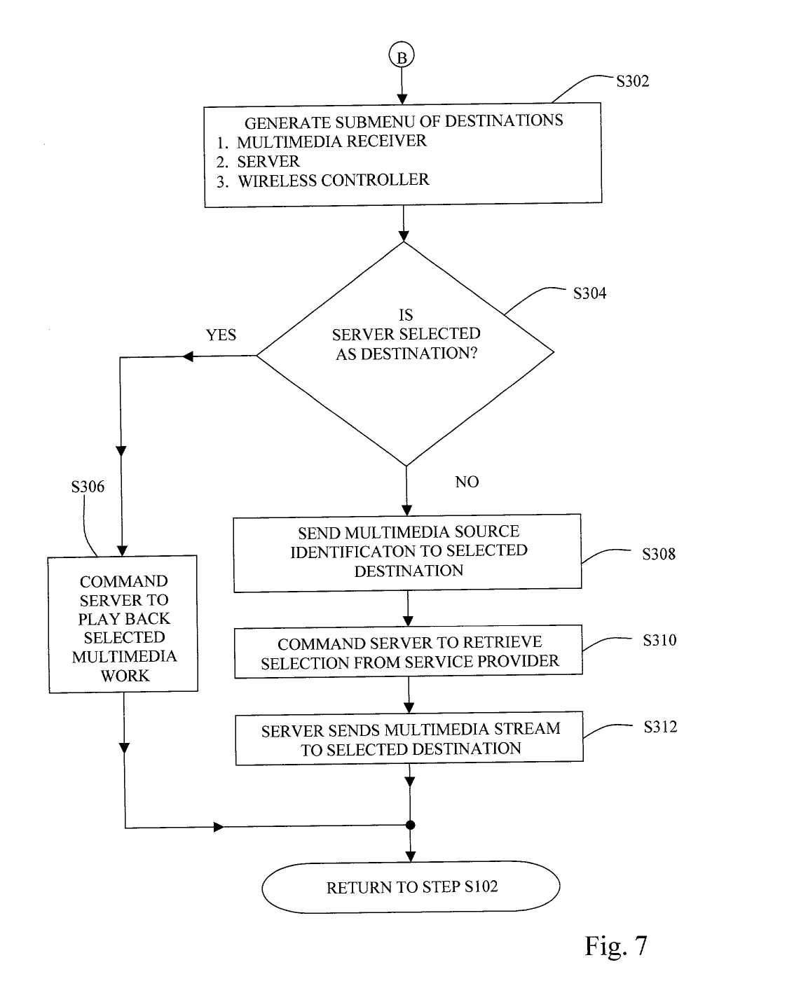

If service provider 42 was selected as the multimedia source, then the process continues at step S302 (see FIG. 7). At step S302, a submenu of multimedia destinations is generated from which the user can select the desired multimedia destination. The submenu of multimedia destinations is generated as follows. Upon selection of the submenu of multimedia destinations by entry of an appropriate input by the user via input unit 90, wireless controller 16 generates a query that is broadcast via Bluetooth RF transceiver 64 to other Bluetooth RF transceivers within the operating range of Bluetooth RF transceiver 64. Any Bluetooth based devices, such as multimedia receiver 20 and server 24, within the transmission range of the broadcast will respond by identifying itself as being an available multimedia destination. In addition, wireless controller 16 is automatically listed as a multimedia destination. The list of available multimedia destinations is then displayed on display unit 88.

At step S304, it is determined whether server 24 was selected as the destination.

If the result of the decision at step S304 is YES, then at step S306 wireless controller 16 transmits a command to server 24 via server/gateway wireless interface 22 for server 24 to retrieve the selected multimedia work from service provider 42 and play back the retrieved multimedia work. Service provider 42 supplies the multimedia work as streaming multimedia data via network 38 to server 24 for playback by server 24. The process then returns to step S102 (FIG. 5).

If the result of the decision at step S304 is NO, then at step S308 wireless controller 16 identifies the multimedia source to the selected destination.

If the destination is wireless controller 16, then wireless controller 16 prepares for receiving the selected multimedia work as streaming multimedia data via Bluetooth RF transceiver 64.

If the destination is multimedia receiver 20, then wireless controller 16 sends an enable command to multimedia system wireless interface 18 to identify to multimedia system wireless interface 18 that service provider 42 is the selected multimedia source. The enable command in turn is processed by Bluetooth baseband 46. Bluetooth baseband 46 then responds by preparing multimedia system wireless interface 18 to receive via Bluetooth RF transceiver 44 the selected multimedia work as streaming multimedia data for further processing and signal conditioning by multimedia system wireless interface 18.

At step S310, wireless controller 16 sends a command server (PC) 24 to retrieve the selected multimedia work from service provider 42.

At step S312, the retrieved multimedia work is then sent as streaming multimedia data via server/gateway wireless interface 22. The process then returns to step S102 (FIG. 5).

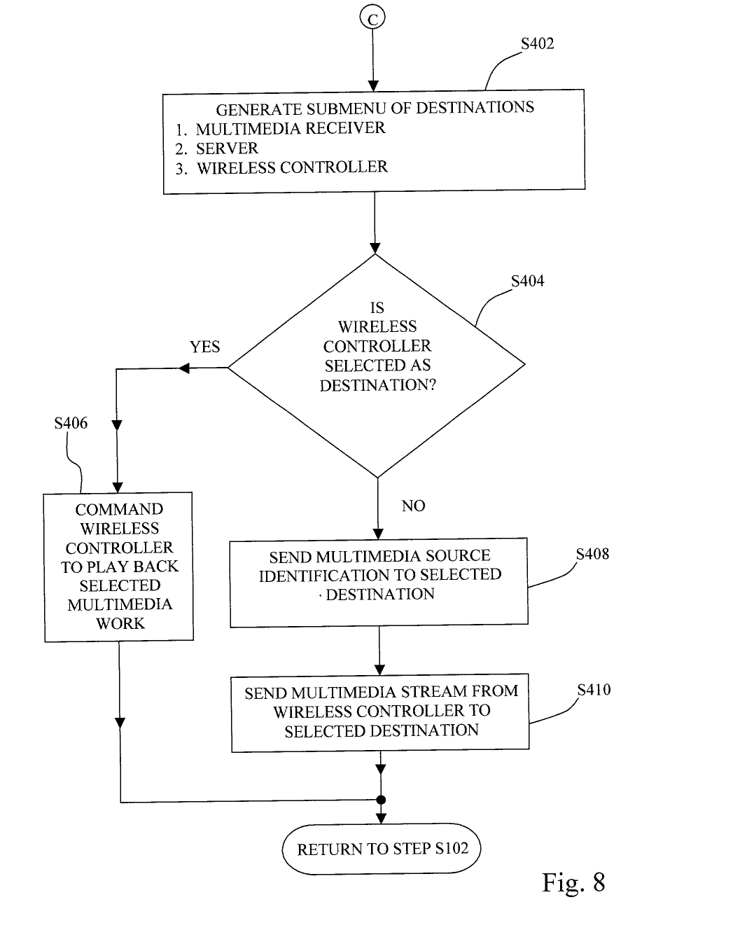

If wireless controller 16 was selected as the multimedia source, then the process continues at step S402 (see FIG. 8). At step S402, a submenu of multimedia destinations is generated from which the user can select the desired multimedia destination. The submenu of multimedia destinations is generated as follows. Upon selection of the submenu of multimedia destinations by entry of an appropriate input by the user via input unit 90, wireless controller 16 generates a query that is broadcast via Bluetooth RF transceiver 64 to other Bluetooth RF transceivers within the operating range of Bluetooth RF transceiver 64. Any Bluetooth based devices, such as multimedia receiver 20 and server 24, within the transmission range of the broadcast will respond by identifying itself as being an available multimedia destination. In addition, wireless controller 16 is automatically listed as a multimedia destination. The list of available multimedia destinations is then displayed on display unit 88.

At step S404, it is determined whether wireless controller 16 was selected as the destination.

If the result of the decision at step S404 is YES, then wireless controller serves as both the multimedia source and the multimedia destination. At step S406 wireless controller 16 internally generates a command to retrieve the selected multimedia work from media memory 70, which in turn is supplied as streaming multimedia data to processor 68, which in turn provides processing and signal conditioning for delivery of the selection to output port 72. The process then returns to step S102 (FIG. 5).

If the result of the decision at step S404 is NO, then at step S408 wireless controller 16 identifies the multimedia source to the selected destination.

If the destination is multimedia receiver 20, then wireless controller 16 sends an enable command to multimedia system wireless interface 18 to identify to multimedia system wireless interface 18 that wireless controller 16 is the selected multimedia source. The enable command in turn is processed by Bluetooth baseband 46. Bluetooth baseband 46 then responds by preparing multimedia system wireless interface 18 to receive via Bluetooth RF transceiver 44 the selected multimedia work as streaming multimedia data for further processing and signal conditioning by multimedia system wireless interface 18.

If the destination is server 24, then wireless controller 16 transmits an enable command to server/gateway wireless interface 22 to identify to multimedia system server/gateway wireless interface 22 that wireless controller 16 is the selected multimedia source. The enable command in turn is processed by Bluetooth baseband 56. Bluetooth baseband 56 then responds by preparing server/gateway wireless interface 22 to receive via Bluetooth RF transceiver 54 the selected multimedia work as streaming multimedia data for further processing and signal conditioning by server/gateway wireless interface 22.

At step S410, wireless controller 16 sends the selected multimedia work as streaming multimedia data via Bluetooth RF transceiver 64. The selected destination then receives, processes and plays back the selected multimedia work. If multimedia receiver 20 was the selected destination, then the selected multimedia work as streaming multimedia data is received and processed at multimedia system wireless interface 18 for playback by multimedia receiver 20. If server 24 was the selected destination, then the selected multimedia work as streaming multimedia data is received and processed at server/gateway wireless interface 22 for playback at server 24.

The process then returns to step S102 (FIG. 5).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for distributing multimedia content, comprising the steps of:
defining a multimedia source for supplying streaming multimedia data;
defining a destination for receiving said streaming multimedia data;
providing a wireless controller communicatively coupled to each of said multimedia source and said destination, said wireless controller being adapted to perform the steps of:
communicating with said multimedia source to generate a first display of a plurality of multimedia works available from said multimedia source;
facilitating a selection of at least one multimedia work from said first display of said plurality of multimedia works; and
upon said selection being made by a user, commanding said multimedia source to send said at least one multimedia work as said streaming multimedia data to said destination.

2. The method of claim 1, wherein said multimedia source is a server communicatively coupled to a wireless interface, said wireless controller communicating with said server via said wireless interface.

3. The method of claim 1, wherein said multimedia source is a service provider communicatively coupled via a network to a server, said server being communicatively coupled to a wireless interface, said wireless controller communicating with said service provider via said wireless interface.

4. The method of claim 1, wherein said multimedia source is said wireless controller, said wireless controller including a media memory for storing multimedia content.

5. The method of claim 1, said wireless controller further performing the step of preparing said destination to receive said streaming multimedia data from said multimedia source.

6. The method of claim 5, wherein said step of preparing comprises said wireless controller identifying said multimedia source to said destination.

7. The method of claim 1, wherein said destination comprises a multimedia receiver communicatively coupled to a wireless interface.

8. The method of claim 7, wherein said multimedia receiver comprises at least one of an audio system and a video system.

9. The method of claim 1, wherein said destination comprises a server communicatively coupled to a wireless interface, said wireless controller communicating with said server via said wireless interface.

10. The method of claim 1, wherein said destination comprises said wireless controller.

11. The method of claim 1, said wireless controller further performing the steps of:
identifying a plurality of multimedia source devices available as said multimedia source for supplying said streaming multimedia data;
generating a second display of said plurality of multimedia source devices; and
facilitating a selection of a first multimedia source device from said plurality of multimedia source devices as said multimedia source for supplying said streaming multimedia data.

12. The method of claim 11, wherein upon said user selecting said first multimedia source device as said multimedia source, generating said first display of said plurality of multimedia works available from said first multimedia source device.

13. The method of claim 12, wherein said plurality of multimedia source devices includes at least one of a server, a service provider coupled to said server via a network, and said wireless controller.

14. The method of claim 13, wherein said server is communicatively coupled to a first wireless interface, said service provider is communicatively coupled via a network to said server, and said wireless controller communicating with said server via said first wireless interface.

15. The method of claim 14, wherein if said user selects one of said server and said service provider as said multimedia source for supplying said streaming multimedia data to said destination, and provided that said destination is not said server, then said wireless controller enabling said destination to receive said streaming multimedia data from said server, and said wireless controller instructing said first wireless interface to establish communications with said destination to transmit said streaming multimedia data to said destination.

16. The method of claim 15, wherein said destination is a multimedia receiver communicatively coupled to a second wireless interface, said wireless controller selectively enabling said second wireless interface to receive said streaming multimedia data from said first wireless interface communicatively coupled to said server.

17. The method of claim 15, wherein said destination is said wireless controller.

18. The method of claim 14, wherein if said user selects one of said server and said service provider as said multimedia source, and said destination is said server, then said wireless controller remotely controlling selection of said at least one multimedia work from the selected multimedia source via said first wireless interface.

19. The method of claim 1, wherein said wireless controller is communicatively coupled to said multimedia source and said destination using a radio frequency standard.

20. The method of claim 1, wherein said wireless controller further performing the steps of:
identifying a plurality of destination devices available as said destination for receiving said streaming multimedia data;
generating a second display of said plurality of destination devices; and
facilitating a selection of at least one destination device from said plurality of destination devices as said destination for receiving said streaming multimedia data.

21. The method of claim 20, wherein said plurality of destination devices includes at least one of a multimedia receiver, a server and said wireless controller.

22. The method of claim 21, wherein said multimedia receiver is communicatively coupled to a wireless multimedia interface, said multimedia receiver receiving said streaming multimedia data from said multimedia source via said wireless multimedia interface when said user selects said multimedia receiver as said destination via said wireless controller.

23. The method of claim 22, wherein said multimedia receiver comprises at least one of an audio system and a video system.

24. The method of claim 21, wherein said server is communicatively coupled to a server/gateway wireless interface, said server receiving said streaming multimedia data from said multimedia source via said server/gateway wireless interface when said wireless controller enables said server/gateway wireless interface.

25. The method of claim 21, wherein said wireless controller receiving said streaming multimedia data from said multimedia source when said user selects said wireless controller as said destination.

26. A system for distributing multimedia content, comprising:
a first wireless interface adapted to be communicatively coupled to a server device, said server providing access to streaming multimedia data;
a second wireless interface adapted to be communicatively coupled to a multimedia playback unit;
a wireless controller for controlling a communication between said first wireless interface, said second wireless interface and said wireless controller, wherein said first wireless interface, said second wireless interface and said wireless controller communicate via a wireless communication standard;
said wireless controller being configured to instruct said server to transmit said streaming multimedia data via said first wireless interface; and
said wireless controller being configured to instruct said second wireless interface to process said streaming multimedia data for playback by said multimedia playback unit.

27. The system of claim 26, wherein said streaming multimedia data is supplied by a service provider coupled to said server via a network.

28. The system of claim 27, wherein said network is the Internet.

29. The system of claim 26, wherein said wireless controller comprises a user interface including a display unit and an input unit.

30. The system of claim 29, wherein said display unit is an LCD display screen.

31. The system of claim 29, wherein said input unit is one of a touch screen and a keypad.

32. The system of claim 29, wherein upon entry of a multimedia source options input at said input unit, said display unit displays a plurality of multimedia source devices from which at least one multimedia work can be selected.

33. The system of claim 32, wherein said plurality of multimedia source devices comprises said server, a service provider available via a network connection to said server, and said wireless controller.

34. The system of claim 32, wherein upon entry of a multimedia source device selected input at said input unit, said display unit displays a plurality of multimedia works available from a first multimedia source device selected from said plurality of multimedia source devices.

35. The system of claim 34, wherein upon entry of a multimedia work selected input at said input unit, selecting a first multimedia work of said plurality of multimedia works.

36. The system of claim 35, wherein upon entry of a destination options input at said input unit, said display unit displays a plurality of multimedia destination devices available as a destination of said first multimedia work.

37. The system of claim 36, wherein said plurality of multimedia destination devices include at least one of said multimedia playback unit, said server and said wireless controller.

38. The system of claim 36, wherein upon entry of a destination selected input at said input unit, selecting a first multimedia destination device from said plurality of multimedia destination devices.

39. The system of claim 38, wherein upon entry of each of said multimedia source options input, said multimedia source device selected input, said multimedia work selected input, said destination options input and said destination selected input, said wireless controller sending a first command to enable said first multimedia destination device to receive said first multimedia work, and sending a second command to instruct said first multimedia source to send said first multimedia work.

40. The system of claim 39, wherein said first multimedia work is sent as said streaming multimedia data.

41. The system of claim 32, wherein upon entry of a destination options input at said input unit, said display unit displays a plurality of multimedia destination devices available.

42. The system of claim 41, wherein upon entry of a destination selected input at said input unit, selecting a first multimedia destination device from said plurality of multimedia destination devices.

43. The system of claim 26, wherein said wireless controller facilitates selection of at least one of a plurality of multimedia works to be transmitted as said streaming multimedia data.

44. The system of claim 26, wherein said streaming multimedia data is supplied by one of a service provider coupled to said server via a network and said server, wherein said wireless controller facilitates selection of one of said service provider and said server as a multimedia source for providing said streaming multimedia data to said multimedia playback unit via said first wireless interface and said second wireless interface.

45. The system of claim 44, wherein said wireless controller sends a first command to enable to said second wireless interface to receive said streaming multimedia data, and sends a second command to instruct said first wireless interface to transmit a first multimedia work as said streaming multimedia data.
